(19) United States
(12) Patent Application Publication
(10) Pub. No.: US 2006/0011076 A1
(43) Pub. Date: Jan. 19, 2006

(54) Template for application of symbols to storage devices and methods of use

(76) Inventor: John P. Durban, Mission Viejo, CA (US)

Correspondence Address: BIOTECHNOLOGY LAW GROUP, C/O PORTFOLIOIP, P.O. BOX 52050, MINNEAPOLIS, MN, 55402, US

(21) Appl. No.: 11/183,044

(22) Filed: Jul. 15, 2005

Related U.S. Application Data
(60) Provisional application No. 60/588,530, filed on Jul. 15, 2004.

(51) Int. Cl. B43L 13/20; B05C 17/06

(52) U.S. Cl. 101/127; 400/129

(57) ABSTRACT

The invention relates to labeling templates that aid in the creation of readable, formatted title and/content text or symbols at one or more locations on a surface of various storage media, or a label affixed thereto. The templates of the invention include one or a series of guide slots or openings preconfigured to a particular media or item surface that allow letters, shapes, or symbols to be applied, while at the same time providing a boundary to limit symbol application to specific locations on one or more surfaces of the storage media As such, the templates of the invention provide for optimized viewing when stored.

### FIELD OF THE INVENTION

The present invention relates to devices that allow for uniform positioning of letters, words, numbers, and other symbol types on forms of storage media, including electronic storage media and containers therefore.

### BACKGROUND OF THE INVENTION

Conventional methods of applying titles, content, and/or other information in symbolic form to items primarily consists of applying pre-printed labels or affixing blank labels proceeded by having to write on the label. Moreover, the application of labels can be time consuming, messy, and often lead to label separation potentially causing jamming of media players or recorders. Additionally, unless specially coated or laminated, labels consist of paper with an adhesive backing that cannot be modified or erased if the user makes an error or wishes to update the content text.

An alternate method of applying content text to a medium such as a compact disk, for example, is to write directly to the non-recordable (protected), or top of the disk in free hand which is often difficult to read and when stored in conventional sleeves, drawers, cases or other holders, titles can not be seen at all. The inability to easily read titles of compact disks stored in conventional or visor type wallets in a vehicle presents the driver with a distraction that can lead to an accident. Another advantage of applying text or symbology directly to most media surfaces is the ability to erase the content text or symbology with ordinary isopropyl alcohol. Once erased the surface can be written on again and again. In data backup applications where the same recordable media is used over and over again, the ability to record the backup date and content upon completion of each back up is of great import.

Yet other alternative conventional lettering systems employ guides that consist of parallel guide slots, which are used primarily to titles and otherwise place identifying or classification text on, for example, mechanical and electrical schematic drawings prior to the introduction of computer aided drafting technology. These and other conventional guides fail to address the lettering requirements of the computer age and do not accommodate the vast array of media types and sizes.

Accordingly, it is an object of the present invention to provide devices and methods of quickly and neatly applying formatted content text or symbology to various electronic media storage devices and other items. It is a further object of this invention to provide a standardized and optimized main title location as to be easily identified when the media is stored among other alike media in a storage system like cases, drawers, wallets and other means of organizing and storing such media without having to remove the item to read the title or contents. Home-recorded movies that are hand titled in a non-standardized fashion often look messy and illegible and when grouped can be visually unappealing. It is a further object of this invention to provide individual or grouped media specific lettering guides with standardized main title and content location optimized for each media type improving productivity in applying the text and locating the media afterwards.

Before describing the instant invention in detail, several terms used in the context of the present invention will be defined. In addition to these terms, others are defined elsewhere in the specification, as necessary. Unless otherwise expressly defined herein, terms of art used in this specification will have their art-recognized meanings.

A “patentable” composition, process, machine, or article of manufacture according to the invention means that the subject matter satisfies all statutory requirements for patentability at the time the analysis is performed. For example, with regard to novelty, non-obviousness, or the like, if later investigation reveals that one or more claims encompass one or more embodiments that would negate novelty, non-obviousness, etc., the claim(s), being limited by definition to “patentable” embodiments, specifically exclude the unpatentable embodiment(s). Also, the claims appended hereto are to be interpreted both to provide the broadest reasonable scope, as well as to preserve their validity. Furthermore, if one or more of the statutory requirements for patentability are amended or if the standards change for assessing whether a particular statutory requirement for patentability is satisfied from the time this application is filed or issues as a patent to a time the validity of one or more of the appended claims is questioned, the claims are to be interpreted in a way that (1) preserves their validity and (2) provides the broadest reasonable interpretation under the circumstances.

A “plurality” means more than one.

A “storage unit”, “container” and the like refer to items in which other articles are stored. Preferably, such devices are specifically designed and adapted for storage of a specific type of item, including storage devices such as electronic media storage devices. For example, in the context of CDs and CR-ROMs, so-called “jewel cases” are used for safely and securing the storage device. Similar articles, typically made from plastic, are used in conjunction with DVDs and various types of tapes, including audio and videocassettes.

### SUMMARY OF THE INVENTION

The present invention relates to novel devices and methods of aiding the application of text or other symbology, whether hand written or applied using a machine or other application process, onto a surface of a storage device, e.g., an electronic media storage device, or other item (e.g., a container or storage unit or storage case for a storage device), or onto a label already placed on the device or other item in a standardized location, thus providing for improved identification and retrieval from, for example, a filing or other storage system.

Other features and advantages of the invention will be apparent from the following drawings, detailed description, and appended claims.

### BRIEF DESCRIPTION OF THE DRAWINGS

FIG. 1 illustrates a representative template for CD/DVD media. The template depicted contains several guide slots positioned over different areas of the storage disk.

FIG. 2 illustrates a representative template for uniform labeling of 3.5-inch computer floppy disk media. The template shown is designed to be folded to envelope the floppy disk by an encompassing outer lip or shoulder to hold the diskette in place while it is being labeled.

FIG. 3 illustrates a representative videocassette-labeling template that provides openings for application of alphanumeric and/or other symbols for certain widely used consumer and professional video recording tape formats. In preferred embodiments, both tape face (i.e., the surface of video cassette to be labeled) and spline guides are provided.

FIG. 4 illustrates a representative template for preferred backup and office media formats that provides for formatted lettering of certain widely used backup media formats and the third cut file folder.

FIG. 5 illustrates a representative template that provides formatted lettering guides for certain widely used broadcast tape media formats.

### DESCRIPTION OF THE PREFERRED EMBODIMENTS

As those in the art will appreciate, the following detailed description describes certain preferred embodiments of the invention in detail, and is thus only representative and does not depict the actual scope of the invention. Before describing the present invention in detail, it is understood that the invention is not limited to the particular templates, storage devices, and methodologies described, as these may vary. It is also to be understood that the terminology used herein is for the purpose of describing particular embodiments only, and is not intended to limit the scope of the invention defined by the appended claims.

The present invention relates to devices and methods that provide for the efficient application of title and/or content information on a uniform or standard position or location on a receiving surface of various types of storage, particularly electronic, media, as well as other items in conjunction with an indelible or standard printing or writing device or instrument. More particularly, the invention relates to an opaque, clear, tinted, colored, and/or translucent, preferably substantially planar, substrate lettering guide, or “shield”, that is specifically designed and manufactured to provide an array of one or more lettering guide slots or openings positioned and formatted for a particular media type or item that can be directly (i.e., directly on a portion of a surface the storage media itself, i.e., the labeling portion) or indirectly (i.e., applied to an intermediate, for example, a label or sticker that is affixed to a surface of the storage media, preferably before a template of the invention is aligned therewith), titled, labeled, or other wise marked with content-identifying text or other symbology (e.g., alphanumeric symbols, pictures, etc.). As will be appreciated, the lettering guide slots or openings direct where lettering (or placement of other symbols) can be applied to the storage media, as those portions of the storage media covered by a solid portion of the shield will be protected, or shielded, from application of the desired symbol(s). The one or more lettering guide slots or openings of a template can be of any desired shape or size.

The templates of the invention can be made from any suitable material, with flexible materials such as plastics being preferred for a variety of reasons, including cost and ease of manufacture, light weight, etc. Other suitable materials include rubber, ceramics, metals, and composite materials (e.g., carbon reinforced plastics and other resin-fiber systems). Depending on the material selected and the particular type of storage unit for which the template is intended for use, those skilled in the art will select a suitable manufacturing process, including molding, extrusion, etc. In preferred embodiments, the lettering guide slots or openings in the template are made at the time the template is produced, although one or more of the openings or slots can be introduced later, for example, by a suitable machining process whereby the openings are machined into a template blank.

Each of the templates of the invention will also be designed to include at least one media retainer element, such as an alignment tab or hole(s). In some embodiments, the templates are manufactured to be substantially planar. Here, “substantially planar” refers to preferred embodiments of the invention, wherein the template in general is flat, without taking into account alignment tabs or retainer elements that may protrude from the upper surface, the lower surface, or both the upper and lower surfaces, of the template. In the context of the invention, an “upper surface” of a template refers to that surface of the device that is opposite of, and thus does not face, the storage media when the template and storage media are aligned, whereas a “media-facing surface” refers to that surface of the template that faces, or is juxtaposed to and thus comes into contact with a surface of the storage media when the template and storage media are aligned.

In some embodiments of the invention, the template is designed and manufactured such that is can be folded, bent, or otherwise deformed by a user to conform with the shape of the storage media to be labeled. This process of folding may itself result in the template sufficiently conforming to the shape of the storage media such that the surface desired to be labeled is exposed for labeling. In other embodiments where the template is folded to conform to the shape of part or all of the storage media, one or more retainer elements (e.g., alignment tabs, locking elements (for example, a protruding pin and hole adapted to receive the pin when the pin is brought into proximity of the hole, for example, upon folding the template) can also be included on the template, preferably on the media-facing surface.

Electronic media storage devices that can be labeled using a template according to the invention include compact disks (CDs), digital video disks (DVDs), laser disks, computer diskettes or “floppy disks” of various sizes, digital audio tapes (DATs), Zip Disks, Jaz disks, QIC Tape, Digital Linear Tape, 4-mm tape, 8-mm tape, full size digital video (DV) tape, micro MV Tape, mini DV Tape, digital video recorder tape of any size or format, VHS video tape, VHS-C video tape, Beta video tape, U-Matic tape, DVC Pro Tape, audio cassettes, audio reel-to-reel tape, film reel cans, file folders, inventory bins, boxes, parts drawers, envelopes, and shipping labels. It is understood that this invention has applications beyond that which is indicated and illustrated herein.

The templates of the invention may be packaged in kits for sale or distribution as single units or in groups. When grouped, it may be preferred to provide a plurality of different templates, wherein each template is designed for use in conjunction with one or more different types of storage media. For example, a package may contain a template for labeling CDs and DVDs, as well as videocassettes (e.g., such as VHS and or Betamax tapes). In the context of CD and DVD labeling, preferred kits include those wherein a template according to the invention is packaged in a container that corresponds to a container in which CDs and DVDs are typically sold. In this way, the container can serve to retain a disk to be labeled. For example, the container is opened and the template removed from the centering pin or spindle. The disk to be labeled is then positioned in the container using the spindle. The template is then aligned with the disk using the spindle. The disk can then marked as desired using the one more labeling slots of the template as a guide for marking the disk.

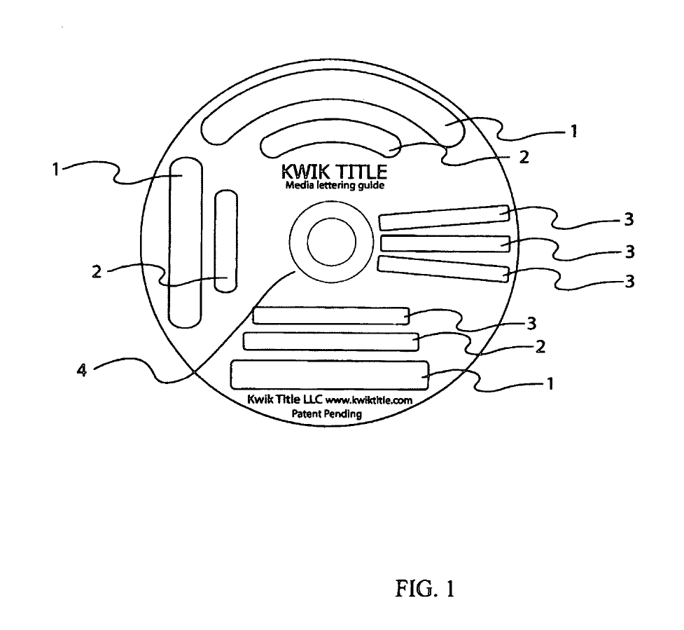

Turning now with reference to the figures, in certain preferred embodiments the templates of the invention are designed and manufactured to closely conform to the size and shape of the storage media with which it is intended to be used. For example, as shown in FIG. 1, a CD/DVD template of the invention (0) is preferably designed and manufactured to match the diameter of a CD or DVD (not shown). In a preferred embodiment, the retainer element (4) of such templates is hole adapted (i.e., sized and shaped) to mate with a spindle (not shown) of a storage unit (not shown) for the particular type of media, which spindle is designed to mate with the disk's center hole. In this way, the template can be easily centered over a CD or DVD, as the case may be, already placed in the storage unit. Such a configuration also provides the ability to rotate the template, thereby permitting partial to nearly continuous rings (or spirals) of information to be applied to a surface of the media (or a label affixed thereto). In FIG. 1, several different configurations of labeling slots or openings (1-3) are depicted, some or all of which may be included in a particular template.

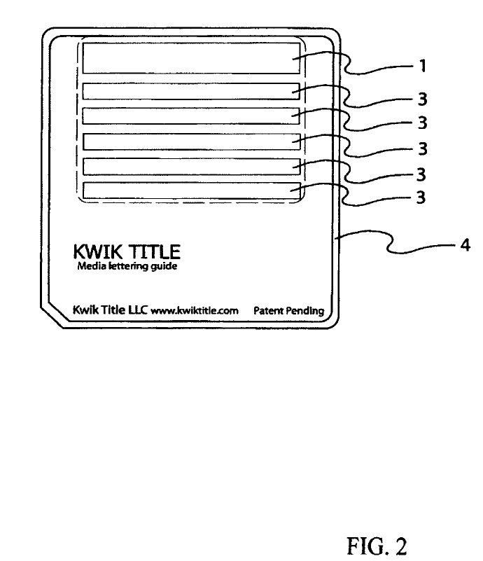

Another preferred embodiment is depicted in FIG. 2, which shows a single floppy disk template (0) designed to match the shape of the media. As shown, this template can, but need not, utilize a slight outer shoulder (4) to allow the template to be aligned with the floppy disk. As shown, this template includes a single large lettering slot (1) to allow marking of the diskette (or a label affixed thereto) in the region underlying the slot, as well as five smaller, spaced slots (3). As will be appreciated, the shoulder retaining element need not be continuous, and need not be present for engaging each side of the floppy disk. Indeed, a single short retaining element protruding from the media-facing surface of the template would be sufficient. If desired, one or more additional retaining elements could be formed into the template. For example, a retaining element designed to engage the “write-protection” window on a floppy diskette when the first retaining element engages the intended side of a diskette could be included, as could other retaining elements designed to engage one or more of the other sides of the diskette when the diskette and template are properly aligned.

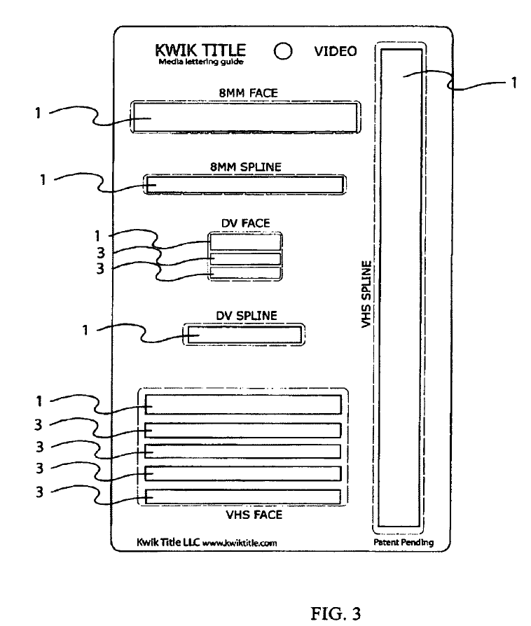

FIG. 3 depicts a template (0) for marking three different videotape cassette formats (VHS or VHS-C, digital video (DV) tape, and 8 mm video tape) in one or more desired locations (e.g., on the face and/or spline of the cassette). In preferred embodiments (and as illustrated in the figure), each format section of the template has highlighted media perimeter artwork matching the physical characteristics of the media itself, thereby allowing the user to optimally align the template with the particular media surface to be marked. In the embodiment shown, one or more labeling slots (1 and 3) are provided for each media surface.

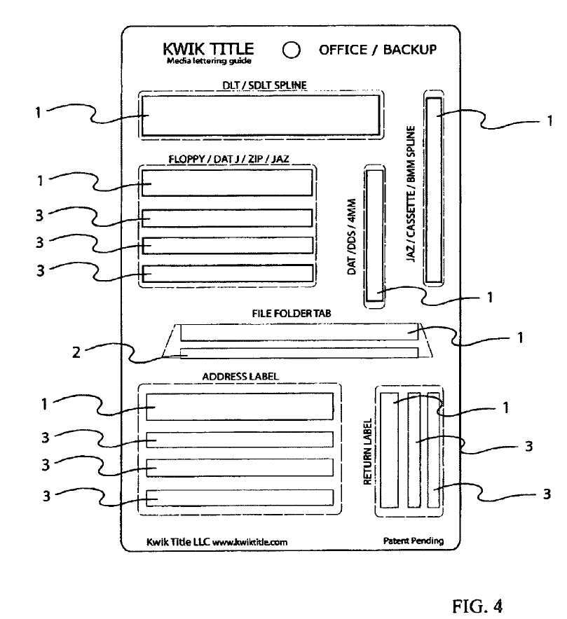

FIG. 4 illustrates another preferred multi-media template of the invention. Specifically, the template shown in the figure provides one or more labeling slots (1 and 3) for each of the types of storage media listed on the template. In particular, the template provides sections for formatted, or position-specific, marking floppy disks, optical disks, tape cartridges, file folder tabs, envelope address and return, and shipping labels, etc., including titling and content by way of title slots (1) and content windows (2 and 3).

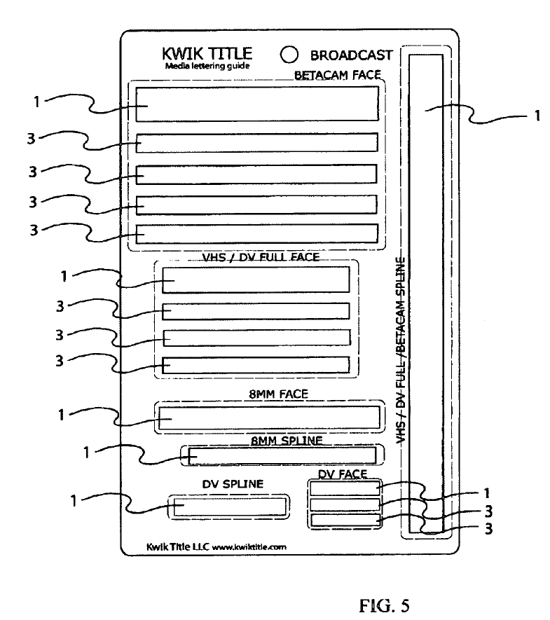

FIG. 5 illustrates another template for multiple media types that provides for formatted titling and content indicia for the various video cassette formats indicated in the figure. Slots for title information (1) and content information (3) for various surfaces on the different cassette types are provided. slots or windows for items like file folder tabs, envelope address and return, and shipping labels.

In a currently preferred embodiment, a package or kit for selling or distributing templates for labeling CDs and DVDs

the media-specific lettering guide, sometimes referred to below as a individual media-specific lettering guide, and other times referred to below as a composite or grouped lettering guide, is capable of providing an improved method of marking on various types of media software.

All of the articles and methods described and claimed herein can be made and executed without undue experimentation in light of the present disclosure. While the articles and methods of this invention have been described in terms of preferred embodiments, it will be apparent to those of skill in the art that variations may be applied to the articles and methods. All such similar substitutes and modifications apparent to those skilled in the art are deemed to be within the spirit and scope of the invention as defined by the appended claims.

All patents, patent applications, and publications mentioned in the specification are indicative of the levels of those of ordinary skill in the art to which the invention pertains. All patents, patent applications, and publications, including those to which priority or another benefit is claimed, are herein incorporated by reference to the same extent as if each individual publication was specifically and individually indicated to be incorporated by reference.

The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

I claim:

1. A template for placing symbology on a storage device, comprising a shield having an upper surface and a media-facing surface and comprising at least one media retainer element and at least one opening in the shield that allows symbology to be placed within a uniform location on a surface of the storage device.

2. A template according to claim 1, wherein the storage device is an electronic media storage device or a device for storing an electronic media storage device.

3. A template according to claim 2, wherein electronic media storage device is selected from the group consisting of a CD, a DVD, a computer diskette, a video tape, and a cassette tape.

4. A template according to claim 1, wherein the shield is substantially planar.

5. A template according to claim 1, wherein the shield is comprised a flexible material.

6. A template according to claim 1, wherein the shield is comprised of a plastic.

7. A template according to claim 1, wherein the shield is opaque, translucent, tinted, or colored.

8. A template according to claim 1, wherein the media retainer element protrudes from the media-facing surface.

9. A template according to claim 1, wherein the media retainer element comprises an additional opening in the shield.

10. A template according to claim 10, wherein the media retainer element comprises a round hole sized and adapted for engaging a CD or DVD centering pin in a CD or DVD storage case.

11. A template according to claim 1, wherein the media retainer element forms by adapting the template to fit over the storage device.

12. A template according to claim 1 that comprises a plurality of openings for placing symbology on a surface of the storage device.

13. A kit comprising a template according to claim 2 packaged in a storage case suitable for storage of the electronic media storage device.

14. A method of preparing a storage device for labeling, comprising aligning a template according to claim 1 with a storage device of the type for which the template is adapted.

15. A method of labeling a storage device, comprising aligning a template according to claim 1 with a storage device of the type for which the template is adapted, and placing symbology on a surface of the storage device exposed through the opening in the shield that allows for symbology placement.
